(19) United States
(12) Patent Application Publication
(10) Pub. No.: US 2026/0147840 A1
(43) Pub. Date: May 28, 2026

(54) SYSTEM AND METHODS OF GENERATING PREVIEWS FOR CONTENT MIGRATION

(71) Applicant: Shopify Inc., Ottawa (CA)

(72) Inventors: Selina ALI, Mississauga (CA); Hugh NGUYEN, Ottawa (CA); Yue YUAN, Brooklyn, NY (US); Jeffrey Zi Tao DENG, Toronto (CA); Sahil KHOJA, Shady Shores, TX (US); David Michael FUTCHER, Edinburgh (GB); Andrey SOLOVIEV, Courbevoie (FR); Gerard KELLY, Dudblin (IE); Rose Elizabeth PENDER, Los Angeles, CA (US)

(73) Assignee: Shopify Inc., Ottawa (CA)

(21) Appl. No.: 18/961,679

(22) Filed: Nov. 27, 2024

(51) Int. Cl. G06F 16/951; G06F 16/38; G06F 16/958

(52) U.S. Cl. CPC G06F 16/951; G06F 16/38; G06F 16/958

(57) ABSTRACT

A computer-implemented method is disclosed. The method includes: obtaining a stack trace associated with an error detected in connection with execution of a computer program by a processor; determining a location of the error within source code of the computer program based on the stack trace, wherein the source code contains a template code section and a custom code section; generating an error message for the error, wherein the generating includes: in response to determining that the error is located in the custom code section, appending a first representation of the stack trace to the error message; and in response to determining that the error is located in the template code section, formatting the error message to indicate a generic template code error, and presenting the error message via a computing device.

### TECHNICAL FIELD

The present application relates to content management systems and, more particularly, to methods for generating real-time previews during content migration.

### BACKGROUND

Content migration is typically triggered when re-platforming websites, upgrading content management systems (CMS), or consolidating content from multiple sources into a single system. Users can specify a source of digital content, such as a website or mobile app, and request that the content be migrated to a target system, platform, or storage location. It is desired to provide tools that facilitate smooth and effective content migration.

### BRIEF DESCRIPTION OF THE DRAWINGS

Reference will now be made, by way of example only, to the accompanying drawings which show example embodiments of the present application, and in which:

FIG. 1 is a schematic diagram illustrating an example operating environment;

FIG. 2 shows, in flowchart form, an example method for generating re-platforming previews when migrating existing content from a website to a target platform;

FIG. 3 shows, in flowchart form, another example method for generating re-platforming previews when migrating existing content from a website to a target platform;

FIG. 4 shows, in flowchart form, an example method for performing migration of website content to a target computer information system;

FIG. 5 is a block diagram of an example computing system, which may be used to implement examples of the present disclosure;

FIG. 6 is a block diagram of a simplified convolutional neural network, which may be used in examples of the present disclosure; and

FIG. 7 is a block diagram of a simplified transformer neural network, which may be used in examples of the present disclosure.

Like reference numerals are used in the drawings to denote like elements and features.

### DETAILED DESCRIPTION OF IMPLEMENTATIONS

In an aspect, the present application discloses a computer-implemented method. The method may include: obtaining web content of a first website hosted on a first platform; determining template requirements of a first template associated with a target platform; obtaining context data characterizing web content elements of the first website; determining a subset of the web content elements to migrate to the target platform based on providing, to a large language model (LLM), instructions to identify relevant web content elements based on the context data and the template requirements; and generating a preview showing the first website migrated to the target platform based on the first template and the identified subset of web content elements.

In some implementations, the web content may comprise image data of images contained on webpages of the first website and the LLM may be provided with instructions to filter the image data to identify a first set of images to include in the preview.

In some implementations, the context data for an image may comprise image metadata that identifies a webpage or a page section associated with the image.

In some implementations, obtaining the web content of the first website may include obtaining only header data for each of the images and determining the subset of the web content elements may include: determining, for each image, an aspect ratio of the image based on the header associated with the image; and selecting images that comply with aspect ratio requirements of the first template for inclusion in the first set of images.

In some implementations, the context data for an image may comprise at least one of: aspect ratio; image reference data; alternative text; color variance; or image dimensions.

In some implementations, the template requirements may define one or more image content placeholders and the LLM may be provided with accompanying text data associated with the one or more image content placeholders and instructions to identify the first set of images based on semantic similarity to the accompanying text data.

In some implementations, the template requirements may define one or more text content placeholders and the accompanying text data may comprise text included in the one or more text content placeholders.

In some implementations, the web content may comprise text contained on webpages of the first website and the LLM may be provided with instructions to: parse a sitemap of the first website to identify webpages that are relevant to the template requirements of the first template; and obtain text from only the identified webpages.

In some implementations, the template requirements may define one or more text content placeholders and generating the preview may include suitably inserting the obtained text into the text content placeholders.

In some implementations, the preview may be generated in real-time based on populating the text content placeholders using the obtained text in accordance with a defined display order of the text content placeholders within the first template.

In another aspect, the present application discloses a computing system. The computing system includes a processor and a memory coupled to the processor. The memory stores computer-executable instructions that, when executed by the processor, may configure the processor to: obtain web content of a first website hosted on a first platform; determine template requirements of a first template associated with a target platform; obtain context data characterizing web content elements of the first website; determine a subset of the web content elements to migrate to the target platform based on providing, to a large language model (LLM), instructions to identify relevant web content elements based on the context data and the template requirements; and generate a preview showing the first website migrated to the target platform based on the first template and the identified subset of web content elements.

In another aspect, the present application discloses a non-transitory, processor-readable medium storing processor-executable instructions that, when executed by a processor, may configure the processor to: obtain web content of a first website hosted on a first platform; determine template requirements of a first template associated with a target platform; obtain context data characterizing web content elements of the first website; determine a subset of the web content elements to migrate to the target platform based on providing, to a large language model (LLM), instructions to identify relevant web content elements based on the context data and the template requirements; and generate a preview showing the first website migrated to the target platform based on the first template and the identified subset of web content elements.

Other example implementations of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “generative AI model” (or simply “generative model”) may be used to describe a machine learning model. A generative AI model may sometimes be referred to, or may use, a language learning model. A trained generative AI model may respond to an input prompt by generating and producing an output or result. The output/result may be generated by the generative AI model through interpreting the intent and context of the prompt. In some cases, the generative AI model may be implemented with constraints on the acceptable prompts. In some cases, this may include a prompt template. A prompt template may specify that prompts have a certain structure or constrained intents, or that acceptable prompts exclude certain classes of subject matter or intent, such as the production of results or outputs that are violent, pornographic, etc.

Significant advances have been made in recent years in generative AI models. Different implementations may be trained to create digital art, computer code, conversation text responses, or other types of outputs. Examples of generative AI models include Stable Diffusion™ by Stability AI Ltd., ChatGPT by OpenAI, DALL-E™ 2 by OpenAI, and GitHub CoPilot™ by GitHub and OpenAI.

The models are typically trained using a large set of training data. For instance, in the case of AI for generating images, the training data set may include a database of millions of images tagged with information regarding the contents, style, artist, context, or other data about the image or its manner of creation. The generative AI trained on such a data set is then able to take an input prompt in text form, which may include suggested topics, features, styles or other suggestions, and provide an output image that reflects, at least to some degree, the input prompt.

### Model-Based Generation of Previews During Content Migration

The process of re-platforming content generally involves migrating content that is stored on a source platform to a target platform. The content assets for migration are catalogued, and the target platform is prepared for data migration. The target platform may be configured by, for example, setting up themes, templates, plugins, and/or third-party integrations. The content is then moved, either automatically or manually, from the source platform to the target platform. In particular, the content assets on the source platform are selectively transferred to and formatted for the target platform. For example, the transferred content assets may be organized according to a new layout or structure.

During content migration, it is desired to provide users with a preview of how the content assets may look and/or function on the target platform. The preview (or “re-platforming preview”) represents a possible snapshot of the migrated content. A key challenge for preview generation is determining the content of the preview in a computationally efficient manner. The preview content is determined by selecting content assets to display as part of the preview. For a seamless user experience, the preview should be generated quickly, without delays in processing the content for migration, in order to avoid latency issues. Large volumes of content or complex content types can complicate the content selection process. The technical challenges associated with determining content of a re-platforming preview may relate to, at least, (1) image selection, and (2) text selection.

Image selection. Websites and mobile app pages typically contain a variety of images with different dimensions and orientations. The images may be selectively migrated to a target platform and formatted in accordance with templates of the target platform. To fit seamlessly into the templates (including any defined image content placeholders), images with suitable aspect ratios should be selected. Improperly sized images can become stretched, skewed, or otherwise deformed during migration, compromising the visual integrity of the preview.

Effective management of image processing load is crucial for optimizing performance during content migration, particularly if a website contains a large number of high-resolution images or complex image effects. The image processing load also affects preview generation. In particular, downloading entire images from the content source in order to assess their suitability for inclusion in a preview can be slow and bandwidth-intensive, and may lead to significant delays in presenting the preview to an end user.

Images that are selected for a re-platforming preview should be substantively significant and contextually relevant. If a target platform has templates (in particular, preview templates) that define one or more content placeholders, images for the preview may be selected based on semantic relevance to the placeholder text. By way of example, it would be preferred to have an image of a trinket, scraped from a source website, positioned next to a content placeholder containing the text, “Timeless Pieces” in the preview. Selecting images simply based on technical criteria without consideration of their content can result in a preview that is fraught with mismatching content elements.

Manually filtering images for relevance may be impractical, especially for websites with extensive image libraries. However, automating the filtering process poses a burden of ensuring that the selected images are both technically suitable and contextually appropriate.

Text selection. A target platform may have templates that define placeholders for specific types and/or sections of content (e.g., “About Us”, “Our Mission”, etc.). In particular, a re-platforming preview may be formatted in accordance with a template having one or more text content placeholders. Inserting text that is scraped from a source website into the placeholders of the preview template in an indiscriminate manner can lead to irrelevant or mismatched content.

The present application discloses a system and methods for generating re-platforming previews. The proposed system leverages use of large language models (LLMs) for relevance-based content filtering and context-aware image and text placement when generating previews during content migration.

The system is configured to automatically extract content from a source, such as an existing website, and filter the extracted content in order to generate a re-platforming preview. For images, the system may perform a quick “aspect ratio determination”. The aspect ratios may be determined based on partial, as opposed to full, image downloads. For example, in some implementations, the system may download only the header portion (e.g., 20 bytes of image data) of images on a website to determine aspect ratio. This approach can minimize bandwidth usage and speed up the initial image filtering process.

The system may also obtain reference data (e.g., image URLs, file names, etc.) of the existing images and utilize an LLM, by providing suitable input prompts, to filter out images that are unsuited for a re-platforming preview. For example, the LLM output may exclude images having generic or unrelated file names (e.g., “paypal-logo.jpg”) and select images with relevant file names (e.g., “bracelet1.jpg”, “about-us.jpg”). Additionally, or alternatively, the system may obtain context data (e.g., aspect ratio, URL, alt text, dimensions) of images in the source and provide the image context data to the LLM in order to determine image relevance. In some implementations, images may be converted to base64 encoded strings along with relevant metadata—such as sections of relevant pages on the website—and the strings may be provided to the LLM. In this way, the LLM can be provided with information on the content of the images, allowing for more contextual and accurate image selections.

A sitemap of the source website can be used for text selection. The system may use an LLM to parse and analyze the website's sitemap, identifying pages that are relevant to the target platform's themes and defined placeholders. More specifically, a mapping may be determined between webpages (as identified using the sitemap) of the source website and placeholders in a template of the target platform. For example, a page entitled “Why we do what we do” in the sitemap may correspond to a content placeholder entitled “Our Mission” in a preview template for the target platform. By scraping the webpages in the order that the corresponding placeholders appear in the template, it may be possible to “stream in” content into the placeholders and update the template in real-time, rather than waiting for all content to be rendered.

In some implementations, the system may also be configured to analyze pages across the existing website to identify common elements (e.g., header, footer, socials, etc.) that are of low content value. These common elements can be stripped out from the content for migration, reducing the total quantity of content assets to provide to an LLM for processing.

To better illustrate additional details regarding the methods and systems of the present application, some concepts relevant to generative AI models, neural networks, and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object class, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train an ML model that is intended to classify images, the training dataset may be a collection of images. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

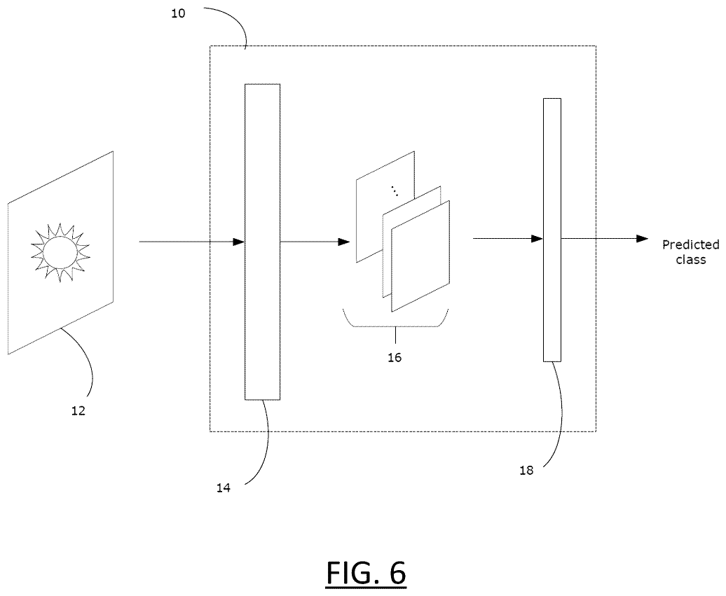

FIG. 6 is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted class or label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted class for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to an ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

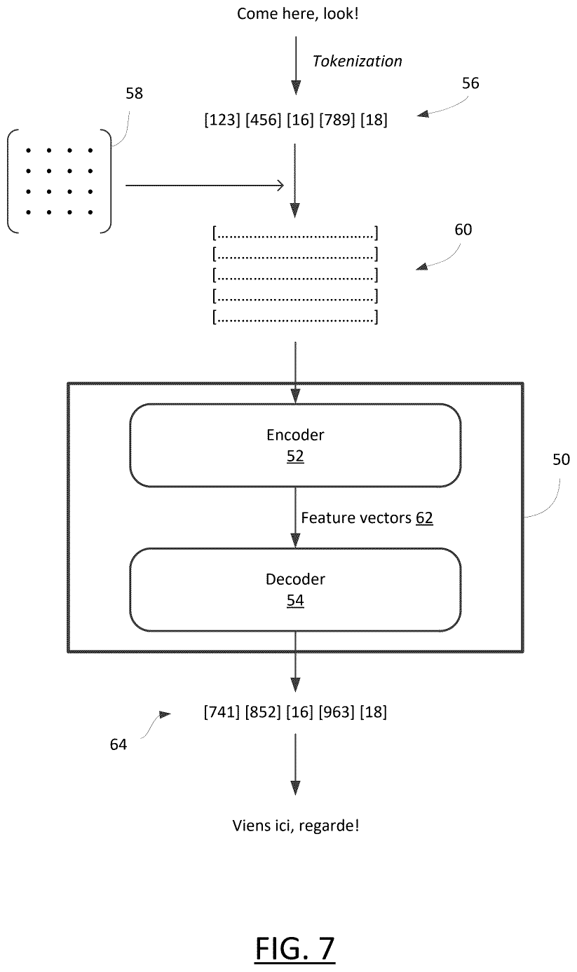

FIG. 7 is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a class of the textual sequence (e.g., may classify the textual sequence as a poem, a list, a paragraph, etc.), a [EOT] token may be another special token that indicates the end of the textual sequence, other tokens may provide formatting information, etc.

In FIG. 7, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 9 for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally, or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally, or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

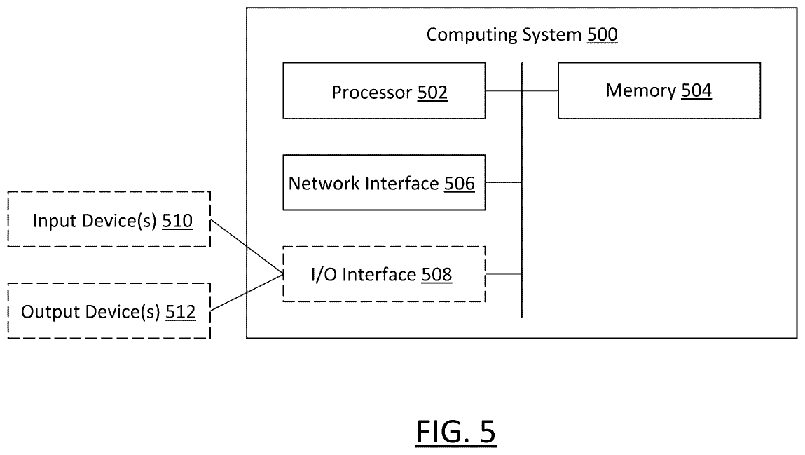

FIG. 5 illustrates an example computing system 500, which may be used to implement examples of the present disclosure, such as a prompt generation engine to generate prompts to be provided as input to a language model such as an LLM. Additionally, or alternatively, one or more instances of the example computing system 500 may be employed to execute the LLM. For example, a plurality of instances of the example computing system 500 may cooperate to provide output using an LLM in manners as discussed herein.

The example computing system 500 includes at least one processing unit, such as a processor 502, and at least one physical memory 504. The processor 502 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 504 may include a volatile or non-volatile memory (e.g., a flash memory, a random-access memory (RAM), and/or a read-only memory (ROM)). The memory 504 may store instructions for execution by the processor 502 to carry out examples of the methods, functionalities, systems and modules disclosed herein.

The computing system 500 may also include at least one network interface 506 for wired and/or wireless communications with an external system and/or network (e.g., an intranet, the Internet, a P2P network, a WAN and/or a LAN). A network interface may enable the computing system 500 to carry out communications (e.g., wireless communications) with systems external to the computing system 500, such as a language model residing on a remote system.

The computing system 500 may optionally include at least one input/output (I/O) interface 508, which may interface with optional input devices 510 and/or optional output devices 512. Input devices 510 may include, for example, buttons, a microphone, a touchscreen, a keyboard, etc. Output devices 512 may include, for example, a display, a speaker, etc. In this example, optional input devices 510 and optional output devices 512 are shown external to the computing system 500. In other examples, one or more of the input devices 510 and/or output devices 512 may be an internal component of the computing system 500.

A computing system, such as the computing system 500 of FIG. 5, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

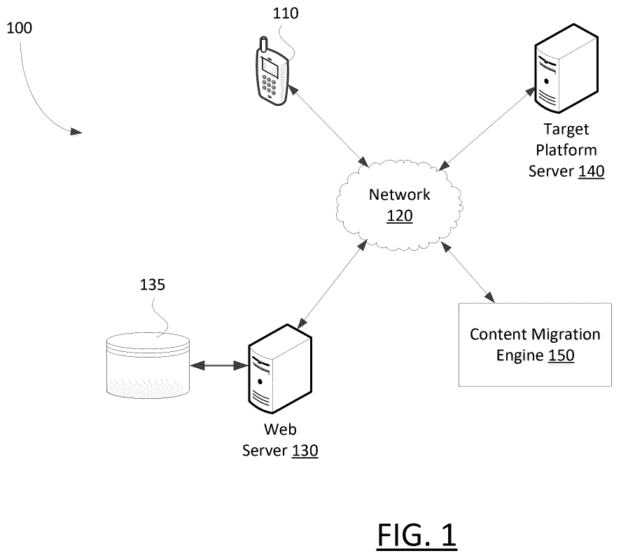

Reference is now made to FIG. 1, which illustrates an exemplary computing environment 100. The computing environment 100 may include one or more client devices 110, a web server 130, a target platform server 140, a content migration engine 150, and a communications network 120 connecting components of the computing environment 100.

The client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type. The client device 110 may store software instructions that cause the client device 110 to establish communications with one or more of: the web server 130, the target platform server 140, and the content migration engine 150.

The computing environment 100 includes a web server 130. The web server 130 is a computing system on which web-based services or applications can be run. In particular, the web server 130 may host one or more web services (or service applications). The web server 130 accepts requests via a network protocol (e.g., Hypertext Transfer Protocol). For example, a client's user agent, such as a web browser, may request a specific resource using HTTP, and the web server 130 may respond by providing content associated with the requested resource or an error message to the client. The content may include static content, such as images, CSS, and JavaScript files, and/or dynamic content (e.g., product recommendations) obtained by, for example, querying databases and processing business logic through server-side applications. The web server 130 may comprise a single computer, an embedded system, or a collection of computers.

In some implementations, the web server 130 may be associated with an e-commerce platform. The web server 130 may serve as an intermediary that processes customer requests, delivers content, and enables customer interactions with merchants. In particular, the web server 130 may implement merchant storefronts of an e-commerce platform by, for example, managing storefront templates, routing customer requests, rendering storefront data, integrating with payment systems, and coordinating session management for customers.

The computing environment 100 includes a content migration engine 150. The content migration engine 150 is designed to streamline the transfer of digital content from one platform to another. As shown in FIG. 1, the content migration engine 150 is connected to source and target platforms via the network 120. The content migration engine 150 handles various functions relating to migration of content between computer information systems and may be employed for a wide range of uses, such as website re-platforming, content archiving and consolidation, and CMS or platform upgrades. The functions of the content migration engine 150 may include, among others: extracting content from a source platform; mapping content elements to a target platform; reformatting content to align with requirements of the target platform; loading content into the target platform; error handling and validation; and handling URL changes and setting up redirects.

In at least some implementations, the content migration engine 150 may be integrated as a component of an e-commerce platform. That is, an e-commerce platform may be configured to implement example embodiments of the content migration engine 150. In particular, the subject matter of the present application, including example methods for model-based generation of previews during content migration, may be employed in the specific context of e-commerce. For example, the content migration engine 150 may be adapted to facilitate real-time generation of re-platforming previews when migrating content, such as merchant storefront data, from a source platform to a target platform.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like. Additionally, or alternatively, the network 120 may be or may include one or more payment networks. The network 120 may, in some embodiments, include a plurality of distinct networks. For example, communications between certain of the computer systems may be over a private network whereas communications between other of the computer systems may be over a public network, such as the Internet.

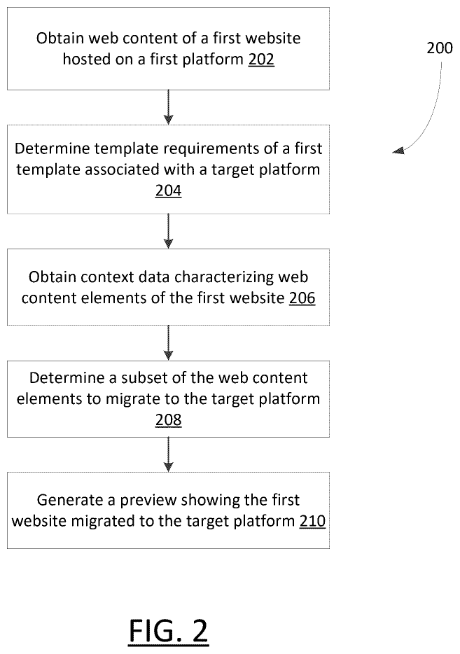

Reference is now made to FIG. 2 which shows, in flowchart form, an example method 200 for generating re-platforming previews when migrating existing content from a website to a target platform. The method 200 may be implemented by a computing system that is designed to automate the transfer of digital content between computer information systems. For example, the operations of method 200 may be performed, entirely or at least partially, by the content migration engine 150 of FIG. 1. The previews may be generated in real-time. In particular, the computing system may provide live previews showing content that has been migrated to and formatted for the target platform.

The computing system catalogs the existing content of a source website. The website content may include articles, images, videos, text, metadata, product schema, SEO data, etc. associated with webpages of the source website. For example, the website content may include webpage and/or image identifiers (e.g., URL, title, file name, file path) or portions thereof. The computing system obtains the web content of the source website (operation 202). For example, the computing system may scan the source website and extract web content. Additionally, or alternatively, the computing system may request to receive, from a web server hosting the web content, content assets associated with the source website. For example, the content assets may be extracted via application programming interface (API) calls and/or queries of database(s) associated with the web server.

The web content may be selectively extracted from the source website for content migration. In particular, the set of all content assets may be “filtered”. For images contained on the source website, the computing system may obtain complete or partial image data of the images. In at least some implementations, the computing system may initially obtain only the header data (e.g., first 20 bytes) of images on the source website. The header data of images may be used for an initial filtering of the images. Specifically, the set of all images on the source website may be filtered to produce a filtered set of images, and this filtered set may be further processed to identify images that will be included in re-platforming previews. As will be explained further below, by limiting the amount of content that is processed by the computing system in selecting the content assets for migration, the processing load for handling the content assets during migration can be minimized.

Existing website content is transferred to a target platform during content migration. In at least some implementations, the target platform is different from the source platform (e.g., web server hosting the source website, social media platform, etc.). The target platform has its own structure and interfaces. In particular, the target platform may be configured by setting up themes, templates, plugins, and/or third-party integrations. The computing system determines how the existing content from the source website will map to the structure of the target platform. Templates are commonly used for structuring migrated content on the target platform. Templates may come in various different forms and include, for example, page layout templates, content block templates, navigation templates, content formatting and style templates, and the like.

In operation 204, the computing system determines template requirements of a first template associated with the target platform. The templates of a target platform define general structure and layouts for different types of pages that are provided by the target system. The first template may, for example, be a layout template, such as a page layout template. In at least some implementations, the template requirements define one or more content placeholders. Each content placeholder is a content block that is associated with a specific type of content. For example, the content placeholders of the first template may include image content placeholders, video content placeholders, text content placeholders, and the like. The template requirements include placeholder data for the content placeholders of the first template, and may specify, for each placeholder: a webpage identifier; a location within the first template; required content type; display dimensions; linked or related placeholder(s) and/or content; and a placeholder title/label/descriptor/identifier.

The computing system obtains context data associated with the web content of the source website, in operation 206. The context data comprises information that provides background, relevance, and situational understanding of the content assets of the source website. This data informs the selection of relevant content assets for migration to the target platform. The context data may include metadata (e.g., tags, categories, keywords, meta descriptions, etc.), temporal context data (e.g., time of content creation, modification, etc.), historical data and engagement metrics, and the like. By way of example, for images on the source website, the context data may comprise one or more of: aspect ratio; image reference/identifier data (e.g., image URL, file name, file path, etc.); alternative (alt) text; color variance; image dimensions; or related page/section identifier.

The set of all content assets of the source website is filtered to determine the content for migration. In at least some implementations, the computing system performs an initial filtering of the content assets. The initial filtering is designed to reduce the amount of content for processing, by applying certain heuristics to determine a filtered set of content assets. By way of example, the computing system may perform an initial filtering on the set of all images of the source website. The computing system may determine, for each image, an aspect ratio of the image based on header data associated with the image. By only scanning the header data (as opposed to the entire image file) of images, it is possible to minimize bandwidth usage and to speed up the content filtering process. The computing system may select, for content migration, only images that comply with aspect ratio requirements, for example, of the first template.

The computing system determines a subset of the content assets of the source website to migrate to the target platform (operation 208). Specifically, the computing system identifies content assets that are likely to be relevant to the target platform. The subset of the content assets is determined based on providing, to a large language model (LLM), instructions to identify relevant content assets from the source website. In particular, the input to the LLM may comprise the context data associated with content assets, the template requirements of the first template (or portions thereof), and input prompt(s) for instructing an LLM to produce a list of the relevant content assets based on the context data and the template requirements.

In at least some implementations, the computing system provides, to the LLM, instructions to filter the set of all images on the source website to identify a first subset of relevant images. The identified images may be included in a re-platforming preview which shows content that has been migrated to and formatted for the target platform. The LLM is provided with image data of images on the source website, or reference data (e.g., image URLs, file names, etc.) for the images. In some implementations, the computing system may obtain text data associated with image content placeholders, and the LLM may be provided with instructions to identify the first subset of images based on the images'semantic similarity to the obtained text data. For example, the text data associated with image content placeholders may comprise text that is included in related text content placeholders. A text content placeholder and an image content placeholder are related if they are located adjacent to each other or otherwise linked by content (e.g., a direct reference from one to the other).

In some implementations, the input to the LLM may include instructions to identify images of the source website that are to be excluded from content migration. For example, the LLM may be instructed to identify a set of images that are least relevant to the target platform and/or the content placeholders of the first template. The computing system may be configured to determine common content elements (e.g., header, footer, socials, etc.) across multiple webpages of the source website that are of low value from a content perspective. These content elements may be stripped from consideration for migration, which reduces the amount of content that needs to be analyzed by the LLM. For example, the common content elements may be identified as part of pre-processing steps prior to instructing an LLM to determine a subset of relevant content assets to migrate to the target platform.

A sitemap of the source website can be used to select text of the source website for migration. In particular, the sitemap may serve as a structured reference that enables identifying webpages from which text may be extracted for migrating to the target platform. For example, in some implementations, the computing system may implement a programmatic check to identify, based on the sitemap, webpages having page titles that match certain predefined titles/labels (“About Us”, “Our History”, etc.) associated with content placeholders or sections. Additionally, or alternatively, an LLM may be provided with instructions to parse the sitemap to identify webpages that are relevant to the template requirements of the first template. Specifically, the computing system may create an input prompt instructing an LLM to analyze the source website's sitemap and identify webpages that are relevant to the target platform's content placeholders, and provide the input prompt to the LLM. Only the text contained in the identified webpages may be considered, or selected, for migrating to the target platform.

In operation 210, the computing system generates a re-platforming preview. The preview, which may be a live preview that is displayed and updated in real-time, is generated based on the first template of the target platform and the identified subset of content assets of the source website. The first template may, for example, be a page layout template for a type of page provided by the target platform. The re-platforming preview may be generated by populating the content placeholders of the first template using the selected content assets from the source website. In particular, the content assets may be selectively inserted into the content placeholders based on a mapping of source content to corresponding fields/placeholders in the first template.

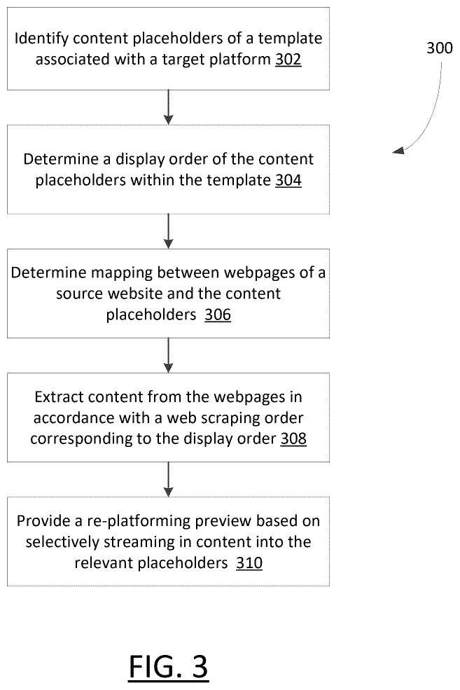

Reference is now made to FIG. 3 which shows, in flowchart form, another example method 300 for generating re-platforming previews when migrating existing content from a website to a target platform. The method 300 may be implemented by a computing system that is designed to automate the transfer of digital content between computer information systems. For example, the operations of method 300 may be performed, entirely or at least partially, by the content migration engine 150 of FIG. 1. The previews may be generated in real-time. In particular, the computing system may provide live previews showing content that has been migrated to and formatted for the target platform. The operations of method 300 may be performed in addition to, or as alternatives of, one or more of the operations of method 200.

A re-platforming preview is useful for visualizing how migrated content will look and/or function on a target platform. Since these previews are intended to be snapshots of the migrated content, it is desired for the previews to be available with little or no delay. In particular, when requested by a user, a re-platforming preview should be generated and displayed in real-time or near real-time. For example, when a user is browsing a source website, it is desired to provide, in real-time, previews of how the webpages of the source website would look on a different platform.

The target platform has a first template defining one or more content placeholders. The use of templates helps to ensure that content migration to the target platform is consistent and smooth. The first template may, for example, be a page layout template. In operation 302, the computing system identifies the content placeholders of the first template. Specifically, the computing system determines placeholder data of the content placeholders which may indicate, for each placeholder: a webpage identifier; a location within the first template; required content type; display dimensions; linked or related placeholder(s) and/or content; and a placeholder title/label/descriptor/identifier.

The computing system determines a display order of the content placeholders within the first template (operation 304). The display order represents an order in which the content placeholders appear in the first template. For example, the display order may be a natural order of navigation (e.g., from top to bottom) of a webpage on the target platform. In at least some implementations, the display order relates to a vertical arrangement of the content placeholders in the first template. According to this approach for determining display order, a first placeholder that is positioned vertically above a second placeholder appears earlier in the display order relative to the second placeholder. Alternatively, the display order may relate to a horizontal arrangement of the content placeholders, e.g., a first placeholder that is positioned to the left of a second placeholder appears earlier in the display order.

In operation 306, the computing system determines a mapping between webpages of the source website and the content placeholders. In some implementations, an LLM may be employed to analyze a sitemap of the source website in order to determine the mapping. For example, the computing system may provide, to an LLM, instructions to determine the mapping based on the sitemap and identifying information for the content placeholders. The mapping may relate, for example, to semantic similarity between the content assets of the webpages and the designated content and/or type of the placeholders. That is, the LLM may be instructed to determine the mapping based on semantic similarity criteria. For example, a source webpage entitled “Why We Do What We Do” in the sitemap may correspond to a “Our Mission” text content placeholder in the first template.

The computing system extracts content from the webpages of the source website in accordance with a web scraping order corresponding to the display order (operation 308). That is, the source webpages are selectively scraped in the order that the corresponding placeholders appear in the first template. By performing content scraping in this manner, it may be possible to “stream in” source content into the placeholders of the first template, as opposed to waiting for all content to be rendered. In particular, the first template may be updated in real-time as the source website is scraped, such that the webpages corresponding to content placeholders that are earlier in the display order are scraped for content before webpages corresponding to content placeholders that are later in the display order.

In operation 310, the computing system provides a re-platforming preview based on selectively streaming in content into the content placeholders. A user may be browsing through webpages of the source website and request a re-platforming preview for one of the webpages, i.e., a webpage currently viewed by the user. The re-platforming preview is designed to show the source content of the current webpage after it has been migrated to and formatted for the target platform. The re-platforming preview may be generated by populating the content placeholders with source content in accordance with the defined display order of the content placeholders within the first template. For example, the content placeholders may be populated with content assets of the current website based on a mapping between source content and the content fields/placeholders. The content assets are transferred to and formatted to fit within the content placeholders. The selection of source content assets for migration to the target platform may proceed in a similar manner as the method described with reference to FIG. 2.

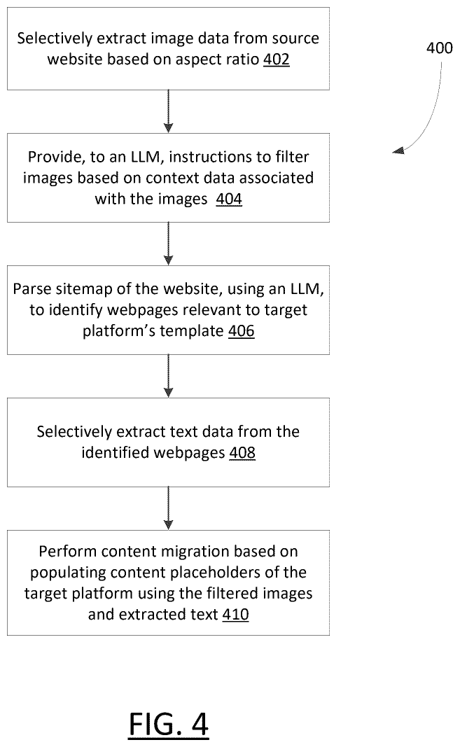

Reference is now made to FIG. 4 which shows, in flowchart form, an example method 400 for performing migration of website content to a target computer information system. The method 400 may be implemented by a computing system that is designed to automate the transfer of digital content between computer information systems. For example, the operations of method 400 may be performed, entirely or at least partially, by the content migration engine 150 of FIG. 1. The previews may be generated in real-time. In particular, the computing system may provide live previews showing content that has been migrated to and formatted for the target platform. The operations of method 400 may be performed in addition to, or as alternatives of, one or more of the operations of methods 200 and 300.

In operation 402, the computing system selectively extracts image data from a source website. More particularly, the computing system obtains partial image data of images contained on the source website. The partial image data may, for example, comprise header data of images that can be used to determine various contextual information regarding the images. By way of example, the header data may include aspect ratio information (or other context data) for the images. The information contained in the header data may, in turn, be used to perform an initial filtering of the source images, in order to obtain a filtered set of images for further processing. The filtered set is a subset of the set of all source images that requires fewer processing resources in selecting the content for migration to a target platform.

The computing system provides, to an LLM, instructions to filter images based on context data associated with the images (operation 404). That is, an LLM is provided with instructions to select a subset of images from the source website for migrating to the target platform. The computing system may provide, as input to the LLM, context data of the images of the filtered set, template requirements of a first template associated with the target platform (including definitions of content placeholders), and instructions to identify content assets for migration based on the context data and the template requirements. The context data may include metadata (e.g., tags, categories, keywords, meta descriptions, etc.), temporal context data (e.g., time of content creation, modification, etc.), historical data and engagement metrics, and the like. By way of example, for images on the source website, the context data may comprise one or more of: aspect ratio; image reference data (e.g., image URL, file name, etc.); alternative (alt) text; color variance; image dimensions; or related page/section identifier.

In operation 406, the computing system parses a sitemap of the source website, using an LLM, to identify webpages that are relevant to the first template and/or its content placeholders. A mapping between the source webpages and the content placeholders may be determined, based on relevance of page content to the placeholders. For example, in some implementations, the computing system may implement a programmatic check to identify, based on the sitemap, webpages having page titles that match certain predefined titles/labels associated with content placeholders or sections. Additionally, or alternatively, the computing system may create an input prompt instructing an LLM to analyze the source website's sitemap and identify webpages that are relevant to the target platform's content placeholders (e.g., based on content similarity criteria), and provide the input prompt to the LLM.

In operation 408, the computing system selectively extracts text data from the identified webpages. In particular, the source webpages may be selectively scraped for content that can be used to populate the content placeholders. For example, as described above, the source webpages may be scraped in accordance with a display order associated with the content placeholders in the first template. In operation 410, the computing system performs content migration based on populating content placeholders of the target platform using the filtered set of images and the extracted text.

It will be understood that the methods and operations thereof may be generalized to content migration scenarios in which existing content is migrated from a variety of different content sources, such as social media platforms, mobile app pages, etc., and not limited to websites.

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some implementations, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method for providing website previews, the method comprising:
extracting web content elements comprising at least images and text of a first website hosted on a first platform based on performing a scan of content of the first website;
determining template requirements of a first template associated with a target platform;
obtaining context data associated with the web content elements of the first website;
determining a first subset of the web content elements to migrate to the target platform based on providing, to a large language model (LLM), instructions to filter the web content elements to obtain a filtered set of contextually relevant web content elements based on the context data and the template requirements; and
generating a preview showing the first website migrated to the target platform based on the first template and the first subset of the web content elements.

2. The method of claim 1, wherein the web content elements comprise image data of images contained on webpages of the first website and wherein the LLM is provided with instructions to filter the image data to identify a first set of images to include in the preview.

3. The method of claim 2, wherein the context data for an image comprises image metadata that identifies a webpage or a page section associated with the image.

4. The method of claim 2, wherein extracting the web content elements of the first website comprises obtaining only header data for each of the images and wherein determining the first subset of the web content elements comprises:
determining, for each image, an aspect ratio of the image based on the header associated with the image; and
selecting images that comply with aspect ratio requirements of the first template for inclusion in the first set of images.

5. The method of claim 2, wherein the context data for an image comprises at least one of: aspect ratio; image reference data; alternative text; color variance; or image dimensions.

6. The method of claim 2, wherein the template requirements define one or more image content placeholders and wherein the LLM is provided with accompanying text data associated with the one or more image content placeholders and instructions to identify the first set of images based on semantic similarity to the accompanying text data.

7. The method of claim 6, wherein the template requirements define one or more text content placeholders and wherein the accompanying text data comprises text included in the one or more text content placeholders.

8. The method of claim 1, wherein the web content elements comprise text contained on webpages of the first website and wherein the LLM is provided with instructions to:
parse a sitemap of the first website to identify webpages that are relevant to the template requirements of the first template; and
obtain text from only the identified webpages.

9. The method of claim 8, wherein the template requirements define one or more text content placeholders and wherein generating the preview comprises suitably inserting the obtained text into the text content placeholders.

10. The method of claim 8, wherein the preview is generated in real-time based on populating the text content placeholders using the obtained text in accordance with a defined display order of the text content placeholders within the first template.

11. A computing system, comprising:
a processor; and
a memory coupled to the processor, the memory storing computer-executable instructions that, when executed by the processor, configure the processor to:
extract web content elements comprising at least images and text of a first website hosted on a first platform based on performing a scan of content of the first website;
determine template requirements of a first template associated with a target platform;
obtain context data associated with the web content elements of the first website;
determine a first subset of the web content elements to migrate to the target platform based on providing, to a large language model (LLM), instructions to filter the web content elements to obtain a filtered set of contextually relevant web content elements based on the context data and the template requirements; and
generate a preview showing the first website migrated to the target platform based on the first template and the first subset of the web content elements.

12. The computing system of claim 11, wherein the web content elements comprise image data of images contained on webpages of the first website and wherein the LLM is provided with instructions to filter the image data to identify a first set of images to include in the preview.

13. The computing system of claim 12, wherein the context data for an image comprises image metadata that identifies a webpage or a page section associated with the image.

14. The computing system of claim 12, wherein extracting the web content elements of the first website comprises obtaining only header data for each of the images and wherein determining the first subset of the web content elements comprises:
determining, for each image, an aspect ratio of the image based on the header associated with the image; and
selecting images that comply with aspect ratio requirements of the first template for inclusion in the first set of images.

15. The computing system of claim 12, wherein the context data for an image comprises at least one of: aspect ratio; image reference data; alternative text; color variance; or image dimensions.

16. The computing system of claim 12, wherein the template requirements define one or more image content placeholders and wherein the LLM is provided with accompanying text data associated with the one or more image content placeholders and instructions to identify the first set of images based on semantic similarity to the accompanying text data.

17. The computing system of claim 16, wherein the template requirements define one or more text content placeholders and wherein the accompanying text data comprises text included in the one or more text content placeholders.

18. The computing system of claim 11, wherein the web content elements comprise text contained on webpages of the first website and wherein the LLM is provided with instructions to:
parse a sitemap of the first website to identify webpages that are relevant to the template requirements of the first template; and
obtain text from only the identified webpages.

19. The computing system of claim 18, wherein the template requirements define one or more text content placeholders and wherein generating the preview comprises suitably inserting the obtained text into the text content placeholders.

20. A non-transitory, computer-readable medium storing instructions that, when executed by a processor, configure the processor to:
extract web content elements comprising at least images and text of a first website hosted on a first platform based on performing a scan of content of the first website;
determine template requirements of a first template associated with a target platform;
obtain context data associated with the web content elements of the first website;
determine a first subset of the web content elements to migrate to the target platform based on providing, to a large language model (LLM), instructions to filter the web content elements to obtain a filtered set of contextually relevant web content elements based on the context data and the template requirements; and
generate a preview showing the first website migrated to the target platform based on the first template and the first subset of the web content elements.
